(19) United States
(12) Patent Application Publication
(10) Pub. No.: US 2009/0276789 A1
(43) Pub. Date: Nov. 5, 2009

(54) UNIVERSAL CLIENT AND FRAMEWORK

(75) Inventors: Yongli WU, North Brunswick, NJ (US); Ramgopal Reddy, Scotch Plains, NJ (US)

Correspondence Address: MORRISON & FOERSTER LLP, 1650 TYSONS BOULEVARD, SUITE 400, MCLEAN, VA, 22102, US

(73) Assignee: SITA Corporation, South Plainfield, NJ (US)

(21) Appl. No.: 12/114,370

(22) Filed: May 2, 2008

(51) Int. Cl. G06F 9/46

(52) U.S. Cl. 719/313

(57) ABSTRACT

A universal client, a universal descriptive message, and a communication framework which enables the use of the universal descriptive message and universal client. The universal client and universal descriptive message eliminate the need for multiple individual application clients by allowing for multiple client applications to communicate with a device using the single universal client.

### FIELD OF THE INVENTION

This invention relates to a universal client, a universal descriptive message, and a communication framework which enables the use of the universal descriptive message and universal client. The universal client and universal descriptive message eliminate the need for multiple individual application clients by allowing for multiple client applications to communicate with a device using the single universal client.

### BACKGROUND OF THE INVENTION

Currently, users desire a number of client applications to run on their various hardware devices. These hardware devices may include wired or wireless PCs (or laptops), PDAs, web tablets, cell phones (including Smartphones), and combinations of the foregoing.

These client programs enable the application to run and communicate either directly or through unique middleware products to the same or various other back end systems. Since each different application requires its own unique software program, a user must wait for a client program to be developed for each application and then they must install this program on each device.

### BRIEF SUMMARY OF THE INVENTION

Described are a universal client, a universal descriptive message and a communication framework which enables the use of the universal client. The universal client eliminates the need for multiple individual application clients by allowing for multiple applications to communicate with a device using the single universal client program. Accordingly, only a single universal client program may need to be developed.

One embodiment is a universal descriptive message including one or more descriptive property types comprising at least one action item initiated by a first client system, wherein the action item relates to a process to be performed on a second client system, and wherein the one or more of the descriptive property types can be dynamically changed throughout a lifetime of the universal descriptive message.

The action item may farther relate to a process to be implemented on a framework system. One or more descriptive property types may include one or more identifiers, message details, or inputs. The descriptive property types may include a freeform message, and categorized message details.

The universal descriptive message may be created at the first client system using a universal client configured to create and interpret universal descriptive messages. The universal descriptive message may be created on a framework system.

The first client system or the second client system may be a personal computer, PDA, web tablet, or cell phone. The first client system or the second client system may be a handheld wireless device.

The first client system or the second client system may be a system running a Enterprise Resource Planning (ERP), email system, or accounting system.

Another embodiment is a method of creating and implementing a universal descriptive message including creating a universal descriptive message at a first client system, transmitting the universal descriptive message from the first client system to a framework system, and receiving the universal descriptive message at a framework system configured to process the universal descriptive message and implement one or more action items on a second client system.

The universal descriptive message may include one or more descriptive property types including at least one action item, and wherein the one or more of the descriptive property types can be dynamically changed throughout a lifetime of the universal descriptive message.

One or more action items to be implemented on the second client system may be implemented by sending the second client a universal descriptive message from the framework system. One or more action items on a second client system may be implemented by the framework utilizing an application programming interface (API) on the second client system.

Yet another embodiment is a method of creating and implementing a universal descriptive message. The method includes receiving at a framework system an instruction from a first client system relating to an action to be taken on a second client system, creating a universal descriptive message at the framework system, and transmitting the universal descriptive message to the second client system in accordance with the instruction.

### BRIEF DESCRIPTION OF THE DRAWINGS

FIG. 1 is diagram of the process flow between application systems and or devices and the framework.

FIG. 2 is a diagram showing how the universal client and the API communicate with the framework.

FIG. 3 shows an example of a universal descriptive message including multiple descriptive property types that can be dynamically changed during run time.

FIG. 4 shows an example of the structure of a descriptive property type.

FIG. 5 shows an example of the process flow for the pushing creation service.

FIG. 6 shows an example of the process flow for the pulling creation service.

FIG. 7 shows an example of the process flow for the processing creation service.

FIG. 8 shows an example of the process flow for the pushing communication service.

FIG. 9 shows an example of the process flow for the pulling creation service.

FIG. 10 shows an example of the process flow for the action actuator service.

FIG. 11 is a flow diagram of the process flow for the mobile solution according to an embodiment of the invention.

### DETAILED DESCRIPTION OF THE INVENTION

Described are a universal client, a universal descriptive message and a communication framework which enables the use of the universal client. The universal client and universal descriptive message eliminate the need for multiple individual application clients by allowing for multiple applications to communicate with a device using the single universal client program. Accordingly, only a single universal client program may be developed for each user device.

The universal client may support multiple applications. In some embodiments the universal client may support one or more Enterprise Resource Planning (ERP) systems. ERP systems integrate the data and processes of an organization into one single system. Typically, ERP systems include may include many hardware and software components, and use a unified database to store data for various functions found throughout the organization. Non limiting examples of appropriate ERP systems include SAP, Oracle, and People Soft. The universal client provides a simple way of interacting with these systems using a single client rather than multiple clients on each device, simplifying application development and deployment for businesses, home, personal, and commercial usage.

Definitions

Following is a brief description of some of the terms used herein:

A universal descriptive message is a message containing descriptive information. It may contain an action item and at least one other descriptive property type. The universal descriptive message may be further developed as a standard protocol. The universal descriptive message may be used for communication between the framework and application systems and or devices.

Descriptive property types are contained within the universal descriptive message. Descriptive property types may include the action item, identifier, input and message details. Others property types may include status, timestamp, process flag, sender & receiver, etc.

The framework enables use of the universal descriptive message and a universal client. It acts as an intermediary between application systems and or devices. Allowing one application system and or device to communicate and initiate processes on the same or another application system and or device. The framework is a general purpose framework that is not limited to any specific application. It may include both software and communications components based around a universal descriptive message. The framework may be part of a separate intermediary system in communication with application systems and or devices using the universal descriptive message to communicate with one another. Alternatively, the framework may be implemented on a application system and or device that is also running other components that are in communication with one or more other application systems and or devices using the universal descriptive message.

The system including the framework may include a memory for storing framework applications and one or more processors for running the framework applications. The framework system may be in communication with application systems and or devices using, for example, wired (e.g., Ethernet, etc.) and/or wireless (e.g., 802.xx, WiFi, WiMax, cellular, etc.) technologies.

The engine is a component of the framework configured to process universal descriptive messages. The engine includes an actuator that invokes any action item along with other descriptive property types described in the universal descriptive message.

The framework may include a repository component, which is a storage location for meta data such as universal descriptive messages, action items etc.

The framework may include a staging area component that contains the transactional data from the universal descriptive message.

The universal client may be an interpreter for the universal descriptive message. It is able to communicate with application systems and or devices and process the action item for the end user through the framework.

The application systems and or devices include systems using the universal descriptive message to communicate with each other. The application systems and or devices may include a source system/back end system, such as a system running an ERP, email system, accounting system etc. The application systems and or devices may also include devices, such as PCs (or laptops), PDAs, web tablets, cell phones (including Smartphones), and combinations of the foregoing. The application systems and or devices may be in communication with the framework system using a variety of wired (e.g., Ethernet, etc.) and/or wireless (e.g., 802.xx, WiFi, WiMax, cellular, etc.) technologies.

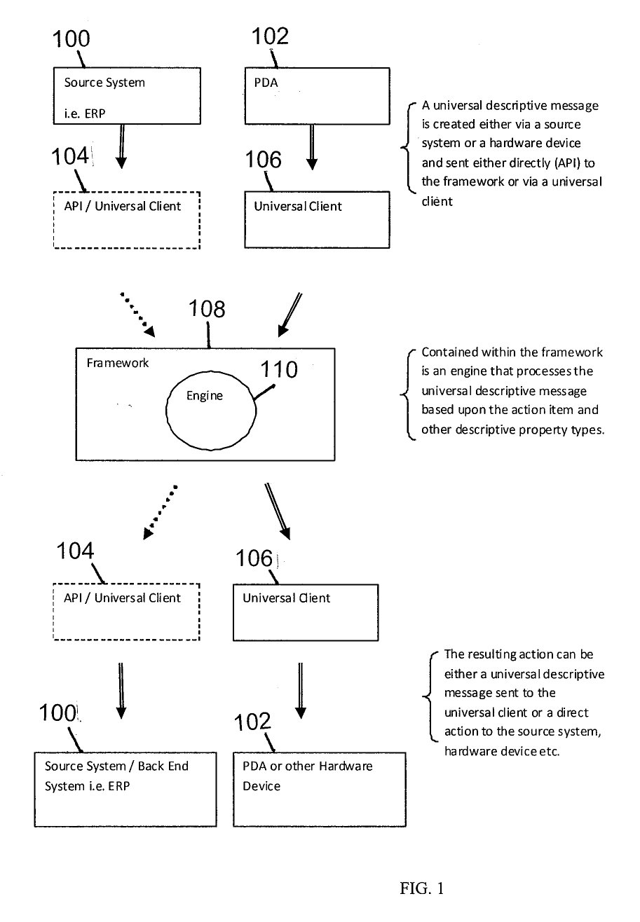

FIG. 1 shows how communication between application systems and or devices including source systems and devices can be achieved using the framework system. In FIG. 1 a source system 100, such as an ERP, or a hardware device 102 such as a PDA, communicates with the framework 108 by creating a universal descriptive message. The universal descriptive message is sent to the framework 108 using either a universal client 104/106 and or using an application programming interface (API) 104. An API is a program specific interface that is designed to allow a program to communicate directly with the framework 108. The universal client is not specific to any one program and allows multiple programs on a device to communicate with the framework.

Contained within the framework 108 is an engine 110 that processes the universal descriptive message based upon an action item and other descriptive property types in the universal descriptive message. The framework 108 then implements the resulting action described in the universal descriptive message. The resulting action can be implemented by sending a universal descriptive message to the universal client 104/106 installed on the source system/back end system 100 or hardware device 102. Alternatively, the framework 108 can implement the action directly without using the universal client 104/106 by communicating directly with the source system/back end system 100 or hardware device 102 using an API 104.

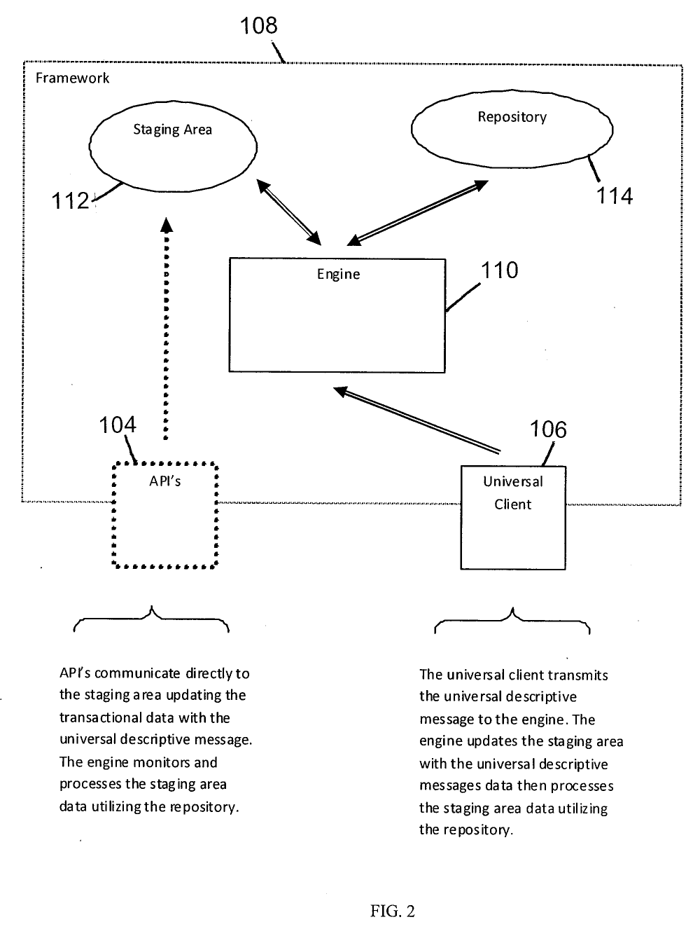

FIG. 2 shows is a diagram showing how the universal client and the API communicate within the framework 108. The API 104 is able to communicate directly to the staging area 112 updating transactional data with the universal descriptive message. The engine 110 monitors and processes the staging area 112 data utilizing the repository 114. In comparison, the universal client 106 transmits the universal descriptive message to the engine 110. The engine 110 updates the staging area 112 with the universal descriptive message data and then processes the staging 112 utilizing the repository 114.

Universal Descriptive Message

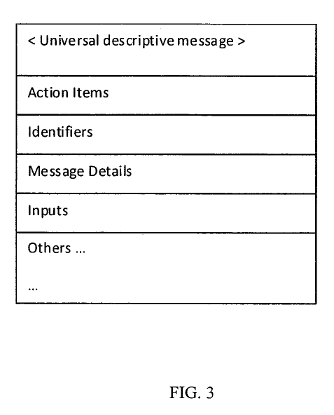

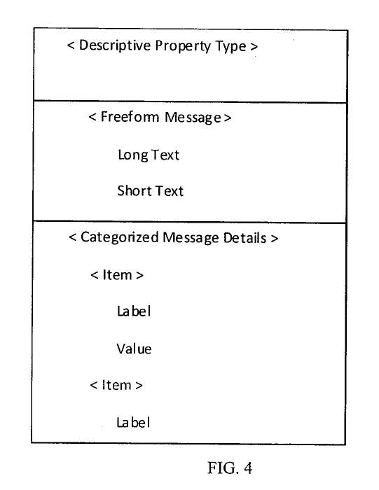

The universal descriptive message will now further be described with respect to FIGS. 3 and 4. FIG. 3 shows an example of a universal descriptive message including multiple descriptive property types that can be dynamically changed during run time. As shown in FIG. 3, the descriptive property types can include, for example, action items, identifiers, message details, and inputs. Other descriptive property types may include, for example, status, timestamp, process flags, sender receiver etc. FIG. 4 shows an example of the structure of a descriptive property type. As shown in FIG. 4, the descriptive property type can include, for example, a freeform message, and categorized message details.

In embodiments, the universal descriptive message may be dynamically changed by any initiating system. The descriptive property type may be dynamically definable and changeable either before or within the universal descriptive message lifetime. The changed universal descriptive message may not affect the involved communication parties in terms of universal descriptive message parsing and processing, etc. The changed universal descriptive message may dynamically update a process or communication requirement at run time.

The universal client (interpreters or presenter) in a destination application system and or device is able to interpret the universal descriptive message dynamically. In some embodiments, each application system and or device involved in the universal descriptive message communication may have a universal client. In other embodiments, one or more of the application system and or device may communicate using an API in place of the universal client.

The universal descriptive message may include a variety of descriptive property types, for example, action items, identifiers, message details, and inputs etc. Each type of the descriptive property types described in the universal descriptive message may have a special process associated with it. A universal descriptive message may have any number of descriptive property types in addition to those described herein. In one embodiment, the universal descriptive message has four predefined descriptive property types, action items, identifiers, message details, and inputs.

Any descriptive property type may preferably be dynamically associated to a specific process. The process associated with the descriptive property type may be handled by the engine of the framework (action actuator invocation service) with a specific sub-services defined dynamically for the universal descriptive message.

One type of descriptive property type is “action item.” The action item descriptive property type is the core value of the framework. This descriptive property type defined in the universal descriptive message may be passed through the communication framework and dynamically defined at runtime. The action item defines a process to be implemented on an application system and or device.

Action items may be processed by the engine (action actuator services) of the framework. The engine may dynamically invoke processing on an application system and or device based upon the action items description using either a universal descriptive message sent to the application system and or device or by utilizing an API on the application systems.

Another type of descriptive property type is “identifiers.” Identifiers may be split into any number of related or non-related fields that may identify the specific object that the universal descriptive message will communicate about. Identifiers are place holders, which hold the information related to specific objects from specific systems (parties) within the universal descriptive message communication framework.

The identifiers may contain critical information for the universal descriptive message creation parties (application system and or device) or universal descriptive message receiving parties (application system and or device) to complete the universal descriptive message lifecycle. Identifiers may be utilized only for communication purposes within the communication framework and are not mandatory.

Yet another type of descriptive property type is “message details.” Message details are utilized for a free formatted message. The information in message details might be further breakdown to message and categorized details. The message is the free form information, exactly as the message is used in the normal message based communication framework, such as email, SMS, etc.

Another type of descriptive property type is “input.” The input descriptive property type may be used for end user data related to the action item.

How a Universal Descriptive Message is Defined

The universal descriptive message maybe dynamically definable in any manner, preferable, via a graphical user interface (GUI). The communications framework may provide a mechanism for dynamically defining the descriptive property type at runtime. The universal descriptive message definition may include predefined descriptive property types. The dynamically defined descriptive property types may be stored in the repository of the framework for immediate runtime access through the engine.

The universal descriptive message may have to include all descriptive property types. In other embodiments, the only mandatory descriptive property type may, for example, be the action item. All others identifiers, message details and inputs, may not be required.

The action item may evoke an API for another application system and or device. A number of action items may be differentiated by their labels. Action items may be related to a single or multi remote process invocations.

In a multi process invocation situation, the transaction control process may be handled by the engine. The defined action item's meta data may be stored in the repository together with the universal descriptive message definition. The stored meta data may be accessed by the engine at run time.

The universal descriptive message may be stored in the staging area either via the engines creation service or an API. The engine may process the universal descriptive message stored in the staging area, specifically the descriptive property types utilizing the meta data found in the repository.

The Universal Client

The universal client is used to present the universal descriptive message and evoke actions from the engine. One embodiment of a universal client is a GUI based universal client that is a user agent of the communication framework. This user agent of the universal client may be able to graphically present the universal descriptive message to the end user and let the end user graphically invoke the action item contained in the descriptive property type.

The user agent of this universal client may be a standalone application working on any hardware device with any software system, such as, but not limited to, a software program running on a mobile device such as PDA, cell phone, PC laptop or desktop, or a piece of software or processor to be used as a plug-in or add-on deployed on top of another user agent, such as an Internet Browser, Microsoft Outlook client, etc.

The universal client may be able to interpret any type of universal descriptive message dynamically. Any action item may be invoked in any manner including via programming, GUI user agent, or interactively by the end user on a device.

The universal client may be able to save locally received universal descriptive messages. Locally saved universal descriptive messages may be processed by the universal client without connecting to the engine. The universal client may be able to sync with the engine, locally saved universal descriptive messages.

The Communication Framework Engine

A universal descriptive message process utilizes an engine with multiple-services used for generating, transferring, processing and handling the universal descriptive message within the communication framework. The multiple services may include, but are not limited to, six services defined for the universal descriptive message communication framework to work, and may also include common system services, such as security, encryptions, etc. The six services for the communication framework may include creation, communication, staging area management, action actuator, API management, and GUI console.

The engine may invoke run time services based upon the descriptive property type status value. These run time services may be creation, communication, staging area management and action actuator. The status values may be defined dynamically by the end user. Six reserved status values may be used for the run time services. These six status values may be NEW, PROCESS, SENT, RESP, CLOSE and PURGE. Additional statuses may be added as required.

The engine processes services that are invoked by the end user. These services may include API management, and GUI console. Additional services and or additional uses for a pre-defined service may be created.

The Engine Creation Service

The engine may include a variety of different universal description message creation services. Three predefined creation services may be, pushing, pulling and processing. Additional creation services can be defined and added into the framework as needed. Two descriptive property status values, used for the creation services may be NEW and PROCESS.

Each creation service may include four steps: 1) definition of the event or flag that initiates the creation; 2) determination of the type of universal descriptive message; 3) collection of all information required to create the message; and 4) generation of the message followed by sending the message to the staging area.

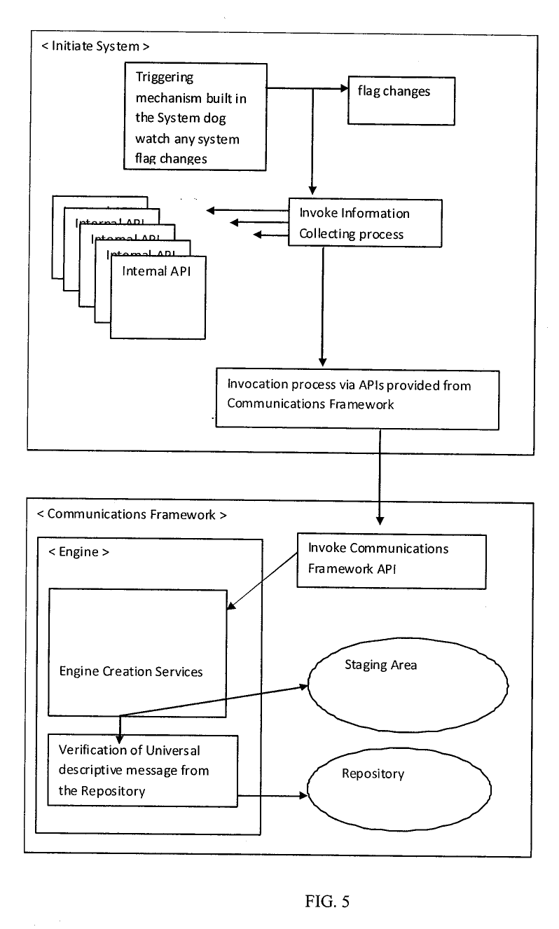

Following is a description of the predefined creation services: pushing, pulling and processing. FIGS. 5-7 show flow processes for each of these creation services.

FIG. 5 shows an example of the process flow for the pushing creation service. The pushing creation service relies on the program or control at the initiating system. There may be a public API for the pushing creation service from any system involved in the communication framework.

The pushing creation service may require no setup with the engine. Instead, the initiating system may be responsible for the four steps for the creation service. The created universal descriptive message by the pushing creation service may have a status value of NEW.

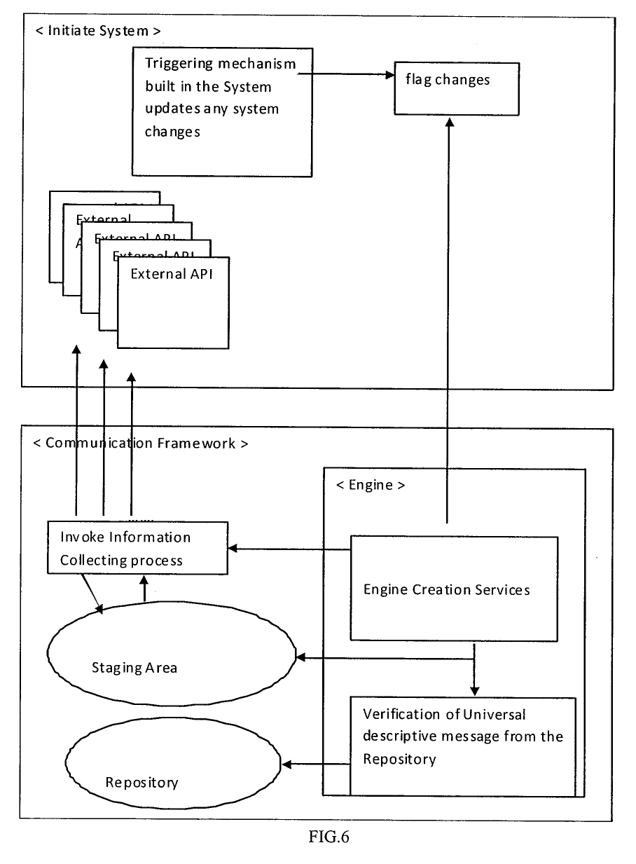

FIG. 6 shows an example of the process flow for the pulling creation service. The pulling creation service relies on the engine to create the universal descriptive message in the staging area. The pulling creation service may require no configuration on the system. The pulling creation service will may utilize the APIs provided by any involved systems.

In the pulling creation service, the engine may be responsible for the four steps for the creation service. The universal descriptive message created by the pulling creation service may have a status value of either PROCESS or NEW.

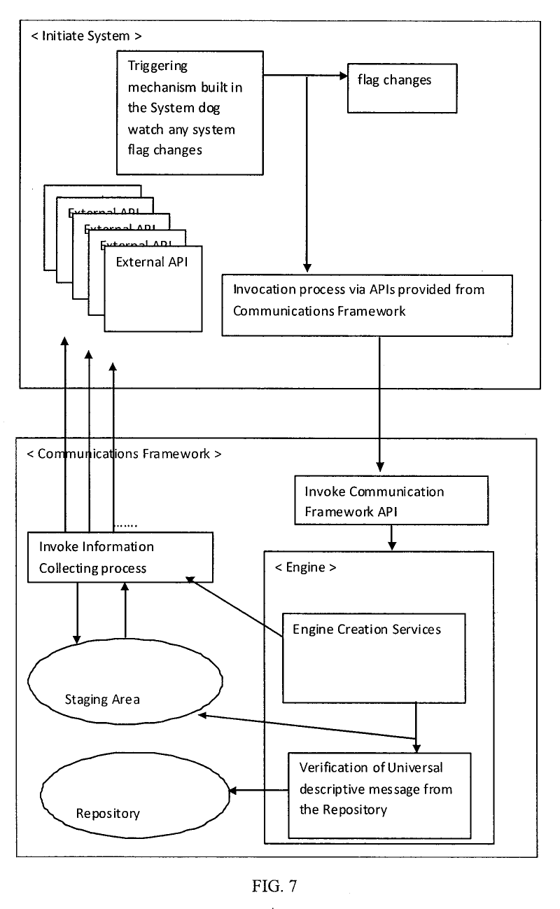

FIG. 7 shows an example of the process flow for the processing creation service. The processing creation service is a combination of both the pushing and pulling creation services.

In the processing creation service, pushing is used for event triggering, and pulling is used to complete the generation of the universal descriptive message. The initiating system is responsible for the first of the four steps for the creation service. The engine is responsible for the other three steps for the creation service. The universal descriptive message created by the processing creation service may have a status value of either PROCESS or NEW.

The Engine Communication Service

The engine communication service is responsible for dispatching the universal descriptive message to the destination, and for receiving the response from the universal client. The communication service is also responsible for updating the universal descriptive message in the staging area to its descriptive property type which may be status value.

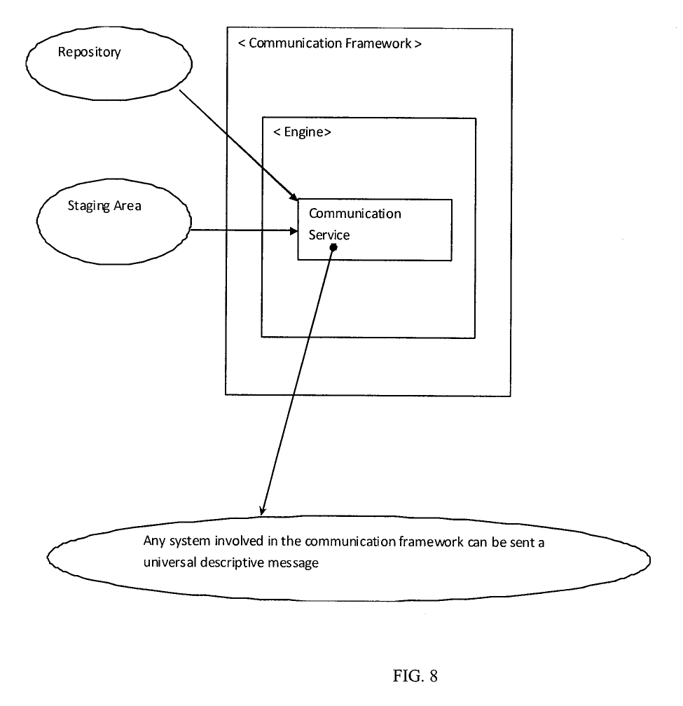

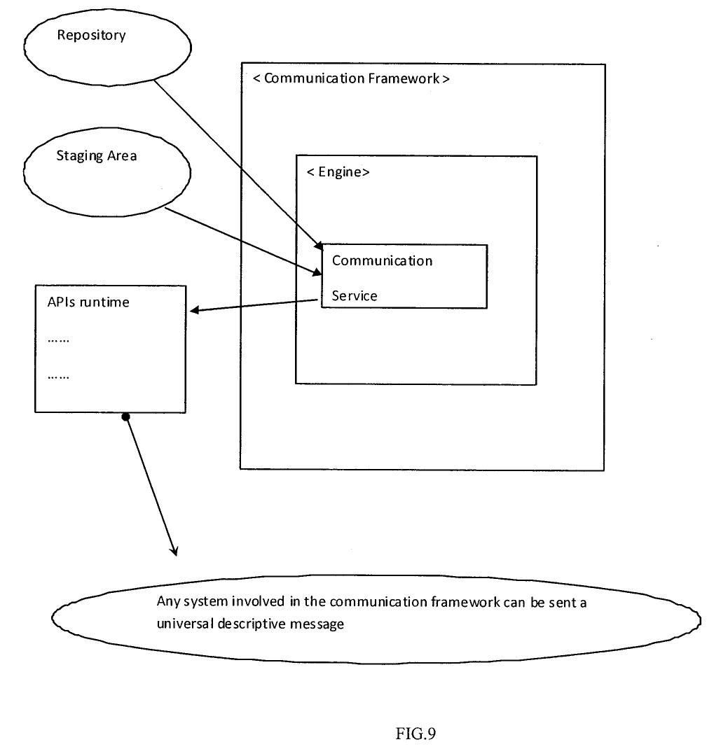

The three status values, out of the six predefined values, for this service are NEW, SENT and RESP. The communication service may have, but is not limited to, three pre-defined services of push, pulling, and update. FIG. 8 shows an example of the process flow for the pushing communication service. FIG. 9 shows an example of the process flow for the pulling creation service.

Whenever there is a message with the status of NEW, the communication service may invoke either the push service or the pulling service to send the message to the destination. Once the services are successfully completed, the status may be updated to SENT.

Whenever the communication service receives a response from any Universal Client, either GUI or programmable, the communication service may update the values within the universal descriptive message and set the status to RESP.

The Engine Staging Area Management Service

The staging area management service handles various house keeping jobs for the staging area. The staging area management may include, but is not limited to two pre-defined services, of CLOSE and PURGE services

Whenever there is a status value of PURGE, the staging area management service may invoke the purge service to eliminate the message from the staging area. Whenever there is a status value of CLOSE, the staging area management service may invoke the close service that changes the status value to PURGE. This allows for backup or monitoring of messages in the staging area prior to deletion.

The Engine Actuator Service

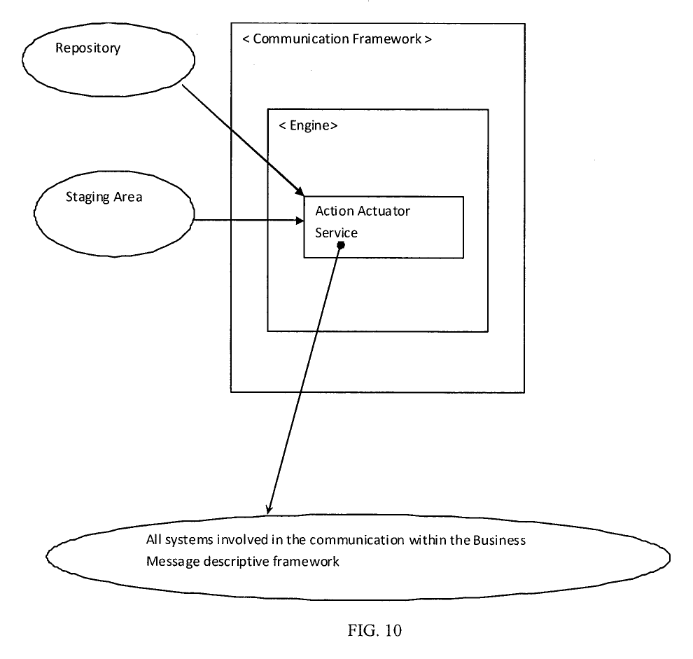

FIG. 10 shows an example of the process flow for the action actuator service. The action actuator service may be capable of interacting with any open API either Web Service, SQL script or proprietary Programming API, etc.

The two status values, out of six predefined values, for this service may be RESP and CLOSE. The action actuator service has but is not limited to one pre-defined service. Whenever there is a status value of RESP, the action actuator service will be invoked to process the universal descriptive message action item. After successful completion of the action item, the status is changed by default to CLOSE.

When an action item within the universal descriptive message requires multiple processes, the action actuator service may provide a mechanism that handles the transition from process to process.

Engine API management service

The API management service is capable of interacting with any open API either Web Service, SQL script or proprietary Programming API, etc. The API management service provides the controls and environment when the communications framework interacts with API's.

Engine GUI console service

The GUI console service provides an admin tool that allows the user to configure the environment.

Universal Descriptive Message Processing

Any systems involved in the communication framework may initiate (instances) the universal descriptive message by referring to the descriptive message type in the repository. The process starts the life of a universal descriptive message's instance. Universal descriptive messages may be created utilizing the descriptive message type defined in the repository of its meta data. The creation can be either by the services of pushing, pulling or processing.

The instances of all generated universal descriptive messages may be kept in the staging area. No matter which systems the universal descriptive message communicates with, the staging area may keep track of the universal descriptive message instance lifecycle.

All instances of universal descriptive messages may have a status, indicating its lifetime stamp, such as NEW, OPEN, PROCESS, RESP, APP, RESP, CLOSE, etc., which can be defined dynamically and processed by specific services. The universal descriptive message has a predefined status used for the universal descriptive message instance lifecycle stamp. The universal descriptive message engine can dynamically add and remove status values and specific services. Usually, each defined status may have a corresponding service. NEW and CLOSE status's may be predefined and reserved for the default Staging Management Service from the Engine.

The communication service may have a push or pull from the engine that may transfer universal descriptive messages from the staging area to the destination of the universal descriptive message. The destination may be either a user or a device which is designated to a specific user.

The engine may process the universal descriptive message in the staging area based on the defined status and invoke the related destination system's API by referring to the meta-data kept in the repository. Based on the status of universal descriptive message in the staging area, the engine may do house cleansing, at the end of the Universal descriptive message instance's lifetime.

### EXAMPLES

This invention will be better understood with reference to the following examples, which are intended to illustrate specific embodiments within the overall scope of the invention.

### Example Email system

Message systems use specific message protocols, such as STMP or POP3 for email, Short message protocol for SMS and long-message protocol, etc. All the message protocols are pre-defined standard and recognized by all communication parties. A protocol is defined with fixed properties, such as destination, send, forward, sender, receiver, timestamp and message content, etc. These properties are the only options the user has available to handle the message in their message system.

People rely on the message systems heavily to communicate with each other for various reasons, but they can only deliver the message via predefined message or an agreed upon protocol. There are currently limited capabilities for people to adapt the existing message systems for their own dedicated purposes either for business processes or for any other specific applications.

For example, if an immediate action is required for a critical situation, a standard notification has been setup to send an email to the one in charge. The email will describe the situation to the one in charge or to the receiver. The receiver will determine based upon resources available the action required. The action could be logging on to a specific system to update some piece of information, etc. A response as simple as an Approval/Reject selection requires the same action. These actions typically cannot be processed via the email, but rather require another system or program to process. Another limited option is an email that has been programmed to have an embedded link to a predefined program that will process the specific action. These are the most widely used approaches today.

One solution to resolve this issue is to let the receiver have an always ready system to respond to all requests. A dedicated application developed for each specific situation. This, however, could potentially require a huge number of dedicated applications.

A solution using the system a universal descriptive message described herein is a descriptive email system, or a plug-in piece of program on Outlook or/and on any other email clients. The user is able to have different email types received for their different response actions. The user has the ability to select an email type that will be created for a specific purpose. These email types can also be dynamically changed.

Examples for the different system architectures for this could be as follows: 1) utilize the framework described herein to develop or configure a new email system; 2) utilize the framework to configure a purely descriptive message system configured at runtime for the email; and 3) within a pre-existing email system plug-in a program either in the email client side or in the email server side or both that will utilize the framework. In anyone of these scenarios, the universal descriptive message may be used for the communication.

In one embodiment, the dedicated descriptive email system may have its own transportation protocol, or use any existing protocols, such as SMTP, POP3 etc. This email system may have an engine to process the email based upon the descriptive content rather than the transportation protocol. For example, if a user wants to forward the email to somebody, in our universal descriptive message, there may be an action item called “FORWARD”, the engine may use the process described in the “FORWARD” action item to forward the email to another person by using whatever standard transportation protocol is used in the system.

With this email system, the email can have dynamically defined action items other than what normal email systems have. For example, if the user has different forwarding options such as “FORWARD_FOR_REVIEW” or “FORWARD_FOR_ACTION”, they can easily define the action item dynamically. When FORWARD_FOR_REVIEW, the forwarded person may only see the message detail, while FORWARD_FOR_ACTION, the forwarded person may respond to the email with other action items, such as APPROVAL, REJECT etc. The action item processes are described in the repository and processed by the engine accordingly.

In another embodiment, the descriptive message system may be configured to be used as an email system as one of its applications. In such a case, the standard email systems may be running independently. A user may utilize a GUI console service to define a universal descriptive message type call “EMAIL”. A pulling process may then be used to retrieve all emails from the standard email systems running elsewhere.

SEND, FORWARD action items may be defined, which send or forward the universal descriptive message from the system to standard email systems via a simple conversion. Although the email content may not be changed, the EMAIL universal descriptive message may allow for additional action items to be included with the standard email. If the user uses the universal client to handle the EMAIL type, the user may be able to take advantage of other actions options.

General process options may be defined at will for normal EMAIL, such as DELETE, RECOGNITION, NOTIFY, SAVE, BACKUP, REMIND or MOVE_TO etc. Any specific process option may be defined dynamically, such as CREATE_ORDER, etc.

A specific service may be defined to convert normal email to specific EMAIL types in the system with either CREATE_ORDER or APPROVAL/REJECT, etc. based on certain criterions.

In yet another embodiment a typical email system may have a plug-in piece of program, which either is in the email client side or in the email server side or both. In the client side plug-in situation, the plug-in piece of software may be able to interpret the descriptive email from email with normal content. It may invoke the plug-in universal client to display the universal descriptive message to the email user with all the action items, etc. The universal descriptive message may be sent to the pre-configured engine, either a dedicated descriptive message system as mentioned above, or a plug-in piece of software in the email server side.

In the Server side plug-in situation, the plug-in piece of software may be able to figure out descriptive email from the email with normal content. It may invoke the plug-in descriptive message engine to process the universal descriptive message based upon its action items description.

The use of the universal descriptive message and framework as described in this example may have many benefits. For example, if an immediate action is required for a critical situation, a standard notification may be setup to send an email to the one in charge. The email may describe the situation to the one in charge or receiver to understand. The email is sent utilizing the universal descriptive message format.

The receiver may determine based upon resources available the action required. The action could be logging on to a specific system to update some piece of information, etc. or a response as simple as an Approval/Reject selection. The email systems described herein may have specific action items defined that the receiver can choose from. These actions may be processed within the email. No addition system or programs may be required to process. Unlike solutions that may require a receiver to have a dedicated application developed for each specific situation, no additional development is required, just configuration within the solution.

Example Universal Descriptive Message Browser

There are currently fixed descriptive messages already in the marketplace, these include HTML and SOAP message etc. These descriptive messages have a predefined protocol for request/response together with a variable content. The content of these messages has descriptive information that allow the user to interpret it differently.

For the HTML situation, the content of HTML is predefined with static descriptive information. The standard tag such as <TABLE> tells the browser to display the content of <table> in a specific way. If you feed the browser with a specific tag <PUBLISH>, it will fail to do anything unless you redevelop the browser for the end user. Whenever the user's interactive GUI is triggered with inputs within the HTML content, the browser will send the information through the request/response protocol to the backend web server, which handles the response.

The web server has nothing to do with the various responses from the HTML consumer, but pass this response to the backend process developed for this HTML content only. If different processes are required, the HTML content and the backend response handler must be redeveloped. However, tools for general purpose usage which can browse any information and invoke any business transaction without changing the HTML code or the backend process handler are currently not available.

The same situation applies to SOAP messages. A SOAP message cannot be defined dynamically. People have to define and design the SOAP message and its fixed content format first. Then the implementation of the SOAP response has to be developed before it can be utilized. After all the development is completed, the SOAP message is published via WSDL. There is no chance to dynamically change the description or processes at any point.

For the HTML, the universal descriptive message can be passed back to the server for the action items to be processed eliminating the need for development. No development is required, we can dynamically configure/define at runtime.

Further, the universal descriptive message and framework can be used for a web service SOAP message either client, server or plug-in with one or both side. If the universal descriptive message is wrapped as a SOAP message, the SOAP client can send the descriptive message via the universal client at the request to the SOAP server. The SOAP server may then delegate the universal descriptive message request to the engine which may process the action items within the universal descriptive message. The response may be sent back to the SOAP server which may wrap the universal descriptive message and send back to SOAP client via our universal client as a SOAP response. In this case, the same SOAP message can be used for totally different applications dynamically changing at runtime using our invention.

Example Mobile Solution

The mobile solution is a universal software client that may replace the need for multiple application programs running on a mobile device. Applications may no longer require their own unique client software. The mobile solution may utilize a deployed software client, a universal client to enable any backend process from the mobile device through one middleware product.

The mobile solution may utilize a communications framework which enables a universal client. The universal client eliminates the need for multiple individual application clients to be installed on a mobile device. The mobile device utilizes the universal client to interact with multiple applications and back end systems. Only one middleware product may be required to communicate with ERP systems such as SAP, Oracle, and People Soft, reducing cost and simplifying application development and deployment for businesses, home, personal, and commercial usage.

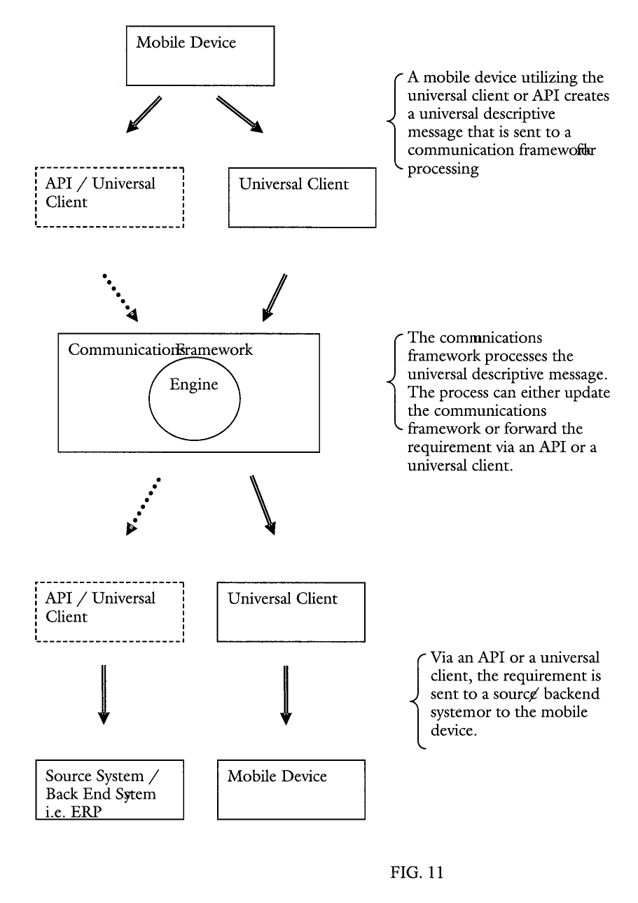

FIG. 11 is a flow diagram of the process flow for the mobile solution according to an embodiment of the invention. The mobile solution may include a universal client installed on the mobile device, and a Communications Framework (middleware) installed on a server. The mobile solution may be easily configurable for any application. Applications include, for example, a message or creating a sales order.

A GUI console service may be used to define specific applications to the communications framework (middleware). Each application may: identify unique ID; identify creation method; identify application location; identify information details for the application which can be graphics, text etc; define the specific action item or multiple action items used in each universal descriptive message; define transactional processes related to each action item; and define any additional information the end user will provide.

On the mobile device, within the universal client, the middleware address may be defined and the universal client may be registered. All applications may be pushed to the universal client.

The mobile device may access or receive messages from the application. An application can be accessed by: 1)opening the universal client on the mobile device; 2) logging onto the universal client; and 3) selecting from the universal client menu the application option that you want to process.

A message from the mobile device may be accessed or responded to according to the following: 1) receipt of messages are pushed to the mobile device from the middleware; 2) the user is notified by the universal client that a message has arrived; 3) the user can then choose to open or save or respond.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

Other embodiments and uses of the invention will be apparent to those skilled in the art from consideration of the specification and practice of the invention disclosed herein. All references cited herein, including all written publications, all U.S. and foreign patents and patent applications, and all published statutes and standards, are specifically and entirely incorporated by reference. It is intended that the specification and examples be considered exemplary only with the true scope and spirit of the invention indicated by the following claims.

1. A universal descriptive message comprising:
one or more descriptive property types comprising at least one action item initiated by a first client system, wherein the action item relates to a process to be performed on a second client system, and wherein the one or more of the descriptive property types can be dynamically changed throughout a lifetime of the universal descriptive message.

2. The universal descriptive message of claim 1, wherein the action item further relates to a process to be implemented on a framework system.

3. The universal descriptive message of claim 1, wherein the one or more descriptive property types further comprise one or more identifiers, message details, or inputs.

4. The universal descriptive message of claim 1, wherein the descriptive property types comprise a freeform message, and categorized message details.

5. The universal descriptive message of claim 1, wherein the universal descriptive message is created at the first client system using a universal client configured to create and interpret universal descriptive messages.

6. The universal descriptive message of claim 1, wherein the universal descriptive message is created on a framework system.

7. The universal descriptive message of claim 1, wherein the first client system or the second client system is a personal computer, PDA, web tablet, or cell phone.

8. The universal descriptive message of claim 1, wherein the first client system or the second client system is a handheld wireless device.

9. The universal descriptive message of claim 1, wherein the first client system or the second client system is a system running a Enterprise Resource Planning (ERP), email system, or accounting system.

10. A method of creating and implementing a universal descriptive message comprising:
creating a universal descriptive message at a first client system;
transmitting the universal descriptive message from the first client system to a framework system; and
receiving the universal descriptive message at a framework system configured to process the universal descriptive message and implement one or more action items on a second client system.

11. The method of claim 10, wherein the universal descriptive message comprises one or more descriptive property types comprising at least one action item, and wherein the one or more of the descriptive property types can be dynamically changed throughout a lifetime of the universal descriptive message.

12. The method of claim 11, wherein the one or more descriptive property types further comprise one or more identifiers, message details, or inputs.

13. The method of claim 11, wherein the descriptive property types comprise a freeform message, and categorized message details.

14. The method claim 10, wherein the universal descriptive message is created at the first client system using a universal client configured to create and interpret universal descriptive messages.

15. The method of claim 10, wherein the first client system or the second client system is a personal computer, PDA, web tablet, or cell phone.

16. The method of claim 10, wherein the first client system or the second client system is a handheld wireless device.

17. The method of claim 10, wherein the first client system or the second client system is a system running a Enterprise Resource Planning (ERP), email system, or accounting system.

18. The method of claim 10, wherein the one or more action items to be implemented on the second client system are implemented by sending the second client a universal descriptive message from the framework system.

19. The method of claim 10, wherein one or more action items on a second client system are implemented by the framework utilizing an application programming interface (API) on the second client system.

20. A method of creating and implementing a universal descriptive message comprising:
receiving at a framework system an instruction from a first client system relating to an action to be taken on a second client system;
creating a universal descriptive message at the framework system; and transmitting the universal descriptive message to the second client system in accordance with the instruction.

21. The method of claim 20, wherein the instruction received from the first client system is in a form of a universal descriptive message.

22. The method of claim 20, wherein the instruction received from the first client system is sent utilizing an application programming interface (API) on the first client system.

23. The method of claim 20, further comprising receiving the universal descriptive message on the second client system utilizing a universal client on the second client system.

24. The method of claim 20, further comprising receiving the universal descriptive message on the second client system utilizing an application programming interface (API) on the second client system.

25. The method of claim 20, wherein the universal descriptive message comprises one or more descriptive property types comprising at least one action item, and wherein the one or more of the descriptive property types can be dynamically changed throughout a lifetime of the universal descriptive message.

26. The method of claim 25, wherein the one or more descriptive property types further comprise one or more identifiers, message details, or inputs.

27. The method of claim 25, wherein the descriptive property types comprise a freeform message, and categorized message details.

28. The method of claim 20, wherein the first client system or the second client system is a personal computer, PDA, web tablet, or cell phone.

29. The method of claim 20, wherein the first client system or the second client system is a handheld wireless device.

30. The method of claim 20, wherein the first client system or the second client system is a system running a Enterprise Resource Planning (ERP), email system, or accounting system.
